(19) United States
(12) Patent Application Publication
(10) Pub. No.: US 2023/0095088 A1
(43) Pub. Date: Mar. 30, 2023

(54) EMOTION RECOGNITION APPARATUS, EMOTION RECOGNITION MODEL LEARNING APPARATUS, METHODS AND PROGRAMS FOR THE SAME

(71) Applicant: NIPPON TELEGRAPH AND TELEPHONE CORPORATION, Tokyo (JP)

(72) Inventors: Atsushi ANDO, Tokyo (JP); Yuki KITAGISHI, Tokyo (JP); Hosana KAMIYAMA, Tokyo (JP); Takeshi MORI, Tokyo (JP)

(73) Assignee: NIPPON TELEGRAPH AND TELEPHONE CORPORATION, Tokyo (JP)

(21) Appl. No.: 17/802,888

(22) PCT Filed: Feb. 28, 2020
(86) PCT No.: PCT/JP2020/008291

§ 371 Date: Aug. 26, 2022

(51) Int. Cl. G10L 25/63; G10L 25/27

(52) U.S. Cl. CPC G10L 25/63; G10L 25/27

(57) ABSTRACT

The present invention provides emotion recognition technology that achieves high emotion recognition accuracy for all speakers. The emotion recognition device comprises an emotion representation vector extraction unit that extracts an emotion representation vector representing emotion information included in input utterance data to be recognized and an emotion representation vector representing emotion information included in preregistered calm emotion utterance data by the same speaker as the input utterance data to be recognized, and a second emotion recognition unit that uses a second emotion recognition model to obtain an emotion recognition result regarding the input utterance data to be recognized from the emotion representation vector of the preregistered calm emotion utterance data and the emotion representation vector of the input utterance data to be recognized, wherein the second emotion recognition model is a model that accepts an emotion representation vector of input utterance data and an emotion representation vector of calm emotion utterance data as input, and outputs an emotion recognition result regarding the input utterance data.

### TECHNICAL FIELD

The present invention relates to emotion recognition technology for recognizing the emotion of a speaker from an utterance.

### BACKGROUND ART

Emotion recognition technology is an important technology. For example, by recognizing the emotion of a speaker during counseling, emotions of anxiety and sadness felt by a patient can be visualized, through which a deeper understanding and improved quality of guidance by the counselor can be anticipated. Also, by recognizing the emotion of a person through interaction between the person and a machine, it is possible to construct a friendlier and more approachable interactive system, such as a system that expresses joy if the person is happy or provides consolation if the person is sad. Hereinafter, a technology that accepts a certain utterance as input and estimates which emotion class (such as calm, angry, happy, or sad, for example) corresponds to the emotion of the speaker who spoke the utterance is referred to as emotion recognition.

Non-Patent Literature 1 is known as an emotion recognition technology of the related art. As illustrated in FIG. 1, in the technology of the related art, acoustic features (such as mel-frequency cepstral coefficients (MFCCs)) of short time periods extracted from an utterance or the signal waveform of the utterance itself are treated as input, and emotion recognition is performed using a classification model based on deep learning.

A classification model 91 based on deep learning includes two layers, namely a time-series model layer 911 and a fully connected layer 912. By combining a convolutional neural network layer with a self-attention mechanism layer in the time-series model layer 911, emotion recognition that focuses on information in a specific segment of an utterance is achieved. For example, it is possible to focus on an extreme increase in the loudness of a voice at the end of an utterance and infer that the utterance corresponds to the angry class. To train the classification model based on deep learning, pairs of an input utterance and a correct emotion label are used. With the technology of the related art, it is possible to perform emotion recognition from a single input utterance.

### CITATION LIST

### Non-Patent Literature

Non-Patent Literature 1: Lorenzo Tarantino, Philip N. Garner, Alexandros Lazaridis, “Self-attention for Speech Emotion Recognition”, INTERSPEECH, pp. 2578-2582, 2019.

### SUMMARY OF THE INVENTION

### Technical Problem

However, in the technology of the related art, bias appears in the emotion recognition results for each speaker. This is because emotion recognition is performed using the same classification model for all speakers and input utterances. For example, utterances by a speaker who normally talks in a loud voice tend to be classified into the angry class for all kinds of utterances, whereas utterances by a speaker who normally talks in a high-pitched voice tend to be classified into the happy class. As a result, the emotion recognition accuracy is lowered for specific speakers.

An objective of the present invention is to provide an emotion recognition device and method that reduce the bias in emotion recognition results for each speaker and achieve high emotion recognition accuracy with respect to all speakers, a device and method for training a model used in emotion recognition, and a program.

### Means for Solving the Problem

To address the above problem, an emotion recognition device according to one aspect of the present invention comprises an emotion representation vector extraction unit that extracts an emotion representation vector representing emotion information included in input utterance data to be recognized and an emotion representation vector representing emotion information included in preregistered calm emotion utterance data by the same speaker as the input utterance data to be recognized, and a second emotion recognition unit that uses a second emotion recognition model to obtain an emotion recognition result regarding the input utterance data to be recognized from the emotion representation vector of the preregistered calm emotion utterance data and the emotion representation vector of the input utterance data to be recognized, wherein the second emotion recognition model is a model that accepts an emotion representation vector of input utterance data and an emotion representation vector of calm emotion utterance data as input, and outputs an emotion recognition result regarding the input utterance data.

To address the above problem, an emotion recognition model training device according to another aspect of the present invention comprises a second emotion recognition model training unit that trains a second emotion recognition model by using emotion representation vectors representing emotion information included in input utterance training data, emotion representation vectors representing emotion information included in calm emotion utterance training data by the same speaker as the input utterance training data, and correct emotion labels for the input utterance training data, wherein the second emotion recognition model is a model that accepts an emotion representation vector of input utterance data and an emotion representation vector of calm emotion utterance data as input, and outputs an emotion recognition result regarding the input utterance data.

### Effects of the Invention

According to the present invention, an advantage of being able to achieve high emotion recognition accuracy for all speakers is exhibited.

### BRIEF DESCRIPTION OF DRAWINGS

FIG. 1 is a diagram for explaining emotion recognition technology of the related art.

FIG. 2 is a diagram for explaining the point of a first embodiment.

FIG. 3 is a function block diagram of an emotion recognition model training device according to the first embodiment.

FIG. 4 is a diagram illustrating an example of a process flow by the emotion recognition model training device according to the first embodiment.

FIG. 5 is a function block diagram of an emotion recognition device according to the first embodiment.

FIG. 6 is a diagram illustrating an example of a process flow by the emotion recognition device according to the first embodiment.

FIG. 7 is a function block diagram of an emotion recognition device according to a second embodiment.

FIG. 8 is a diagram illustrating an example of a process flow by the emotion recognition device according to the second embodiment.

FIG. 9 is a function block diagram of an emotion recognition device according to a third embodiment.

FIG. 10 is a diagram illustrating an example of a process flow by the emotion recognition device according to the third embodiment.

FIG. 11 is a diagram illustrating an exemplary configuration of a computer to which the method is applied.

### DESCRIPTION OF EMBODIMENTS

Hereinafter, embodiments of the present invention will be described. Note that in the drawings referenced in the following description, components having the same function and steps performing the same process are denoted with the same signs, and a duplicate description is omitted. In the following description, a process performed in units of each element of a vector or matrix is assumed to be applied to all elements of the vector or matrix, unless specifically noted otherwise.

### Point of First Embodiment

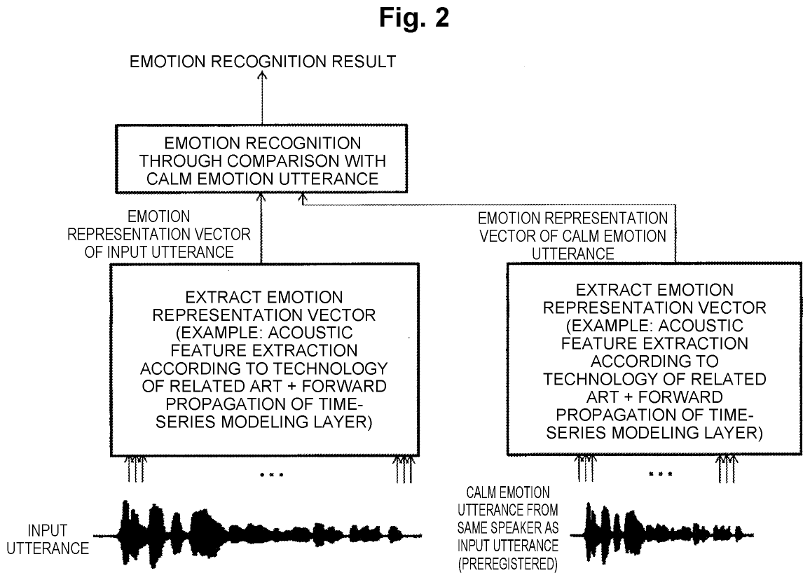

The point of the present embodiment will be described using FIG. 2. The point of the present embodiment is that rather than performing emotion recognition on the basis of an input utterance only as in the technology of the related art, an utterance spoken by a certain speaker with a “calm” emotion (hereinafter also referred to as a calm emotion utterance) is preregistered, and emotion recognition is performed on the basis of a comparison between the input utterance and the preregistered calm emotion utterance.

Humans are typically able to perceive the emotion of a known person's voice accurately, regardless of natural differences in how the person speaks. This being the case, the present embodiment postulates that “when a human estimates the emotion from an input utterance, he or she is using not only features regarding the way of speaking (such as a loud voice, for example) in the input utterance, but also changes from the way of speaking for ordinary utterances (calm emotion utterances) by the speaker”. This emotion recognition using “changes from the way of speaking for ordinary utterances” may potentially reduce the bias in the emotion recognition results for each speaker. For example, with respect to a speaker who speaks in a loud voice, information indicating that calm emotion utterances by the speaker are in a loud voice can be given, thereby deterring estimation results biased toward the angry class.

### First Embodiment

The emotion recognition system according to the present embodiment includes an emotion recognition model training device 100 and an emotion recognition device 200. The emotion recognition model training device 100 accepts input utterance training data (speech data), correct emotion labels for the input utterance training data, and calm emotion utterance training data (speech data) as input, and trains an emotion recognition model. The emotion recognition device 200 uses the trained emotion recognition model and preregistered calm emotion utterance data (speech data) from the speaker corresponding to input utterance data (speech data) to be recognized, recognizes the emotion corresponding to the input utterance data to be recognized, and outputs a recognition result.

The emotion recognition model training device and the emotion recognition device are special devices configured by loading a special program into a publicly known or special-purpose computer including components such as a central processing unit (CPU) and main memory (random-access memory (RAM)), for example. The emotion recognition model training device and the emotion recognition device executes processes under the control of the central processing unit, for example. Data inputted into the emotion recognition model training device and the emotion recognition device and data obtained by the processes is stored in the main memory, and data stored in the main memory is read out to the central processing unit as needed and used in other processes, for example. At least a portion of the emotion recognition model training device and the emotion recognition device may also be configured by hardware such as an integrated circuit. Each storage unit provided in the emotion recognition model training device and the emotion recognition device may be configured by main memory such as random-access memory (RAM) or middleware such as a relational database or a key-value store, for example. However, each storage unit does not necessarily have to be provided internally in the emotion recognition model training device and the emotion recognition device, and may also be configured as an auxiliary memory device including a hard disk, an optical disc, or a semiconductor memory element such as flash memory, and may be provided externally to the emotion recognition model training device and the emotion recognition device.

Hereinafter, each device will be described.

<Emotion Recognition Model Training Device 100>

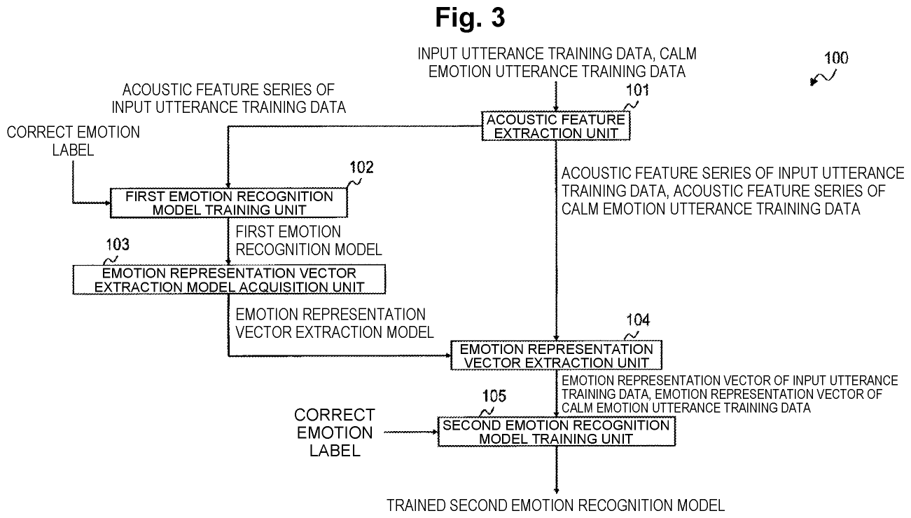

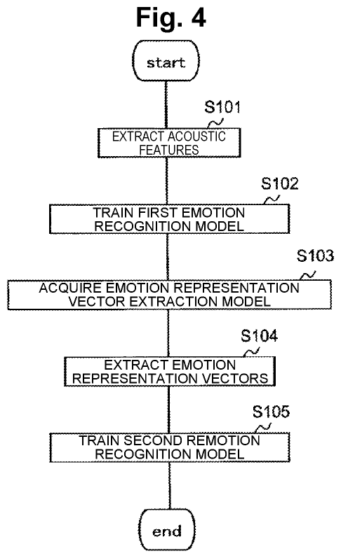

FIG. 3 is a function block diagram of the emotion recognition model training device 100 according to the first embodiment, and FIG. 4 illustrates a process flow by the same.

The emotion recognition model training device 100 includes an acoustic feature extraction unit 101, a first emotion recognition model training unit 102, an emotion representation vector extraction model acquisition unit 103, an emotion representation vector extraction unit 104, and a second emotion recognition model training unit 105.

The emotion recognition model training device 100 accepts input utterance training data, correct emotion labels corresponding to the input utterance training data, and calm emotion utterance training data from the same speaker as the input utterance training data as input, trains an emotion recognition model through comparison with calm emotion utterances, and outputs a trained emotion recognition model. Hereinafter, the emotion recognition model obtained through comparison with calm emotion utterances is also referred to as the second emotion recognition model.

First, the emotion recognition model training device 100 prepares many combinations of three types of data, namely the input utterance training data, the correct emotion labels for the input utterance training data, and the calm emotion utterance training data by the same speaker as the input utterance training data. The speaker of the input utterance training data may be different for each piece of input utterance training data, or may be the same. In order to accommodate utterances by various speakers, it is preferable to prepare input utterance training data from various speakers, but two or more pieces of input utterance training data may also be obtained from a certain speaker, for example. Note that, as described earlier, the speaker of the input utterance training data and the speaker of the calm emotion utterance training data included in a certain combination are assumed to be the same. Moreover, the input utterance training data and the calm emotion utterance training data included in a certain combination are assumed to be utterance data based on different utterances.

Next, the emotion recognition model training device 100 extracts vectors representing emotion information included in each utterance from the input utterance training data and the calm emotion utterance training data. Hereinafter, a vector representing emotion information is also referred to as an emotion representation vector. The emotion representation vector may also be considered to be a vector that contains emotion information. An emotion representation vector may be the intermediate output of a classification model based on deep learning, or utterance statistics about an acoustic feature in respective short time periods extracted from an utterance.

Finally, the emotion representation vector of the calm emotion utterance training data and the emotion representation vector of the input utterance training data are treated as input while the correct emotion labels of the input utterance training data are treated as teaching data to train a model that performs emotion recognition on the basis of the two emotion representation vectors. Hereinafter, this model is also referred to as the second emotion recognition model. The second emotion recognition model may be a deep learning model included in a fully connected layer, or a classifier such as a support vector machine (SVM) or a decision tree. Additionally, the input into the second emotion recognition model may be a supervector obtained by concatenating the emotion representation vector of the calm emotion utterance and the emotion representation vector of the input utterance, or a vector of the difference between the two emotion representation vectors.

When executing the emotion recognition process, input utterance data to be recognized and preregistered calm emotion utterance data by the same speaker as the input utterance data to be recognized are both used to perform emotion recognition.

In the present embodiment, a portion of a classification model based on deep learning according to the technology of the related art is used in the extraction of an emotion representation vector. However, the emotion representation vector extraction does not necessarily have to use a specific classification model, and utterance statistics about an acoustic feature series may also be used, for example. In the case of using utterance statistics about an acoustic feature series, the emotion representation vector is expressed by a vector including one or more from among the mean, the variance, the kurtosis, the skewness, the maximum value, or the minimum value, for example. In the case of using utterance statistics, the emotion representation vector extraction model described later is unnecessary, and furthermore the first emotion recognition model training unit 102 and the emotion representation vector extraction model acquisition unit 103 described later are also unnecessary. Instead, the configuration includes a calculation unit not illustrated that calculates the utterance statistics.

Also, in the construction of the emotion representation vector extraction model and the construction of the second emotion recognition model, the exact same “pairs of input utterance training data and correct emotion labels” may be used, or respectively different “pairs of input utterance training data and correct emotion labels” may be used. However, the correct emotion labels are assumed to have the same set of emotion classes. For example, it must not be the case that a “surprised” class exists in one (the construction of the emotion representation vector extraction model) but does not exist in the other (the construction of the second emotion recognition model).

Hereinafter, each unit will be described.

<Acoustic Feature Extraction Unit 101>

Input: input utterance training data; calm emotion utterance training data

Output: acoustic feature series of input utterance training data; acoustic feature series of calm emotion utterance training data

The acoustic feature extraction unit 101 extracts an acoustic feature series from each of the input utterance training data and the calm emotion utterance training data (S101). An acoustic feature series refers to a series obtained by dividing an input utterance into short time windows, calculating an acoustic feature in each short time window, and arranging a vector of the acoustic features in time-series order. The acoustic features are assumed to include one or more from among the MFCCs, the base frequency, the logarithmic power, the harmonics-to-noise ratio (HNR), the speech probability, the number of zero-crossings, or first-order derivatives or second-order derivatives of the above. The speech probability is calculated according to the likelihood ratio of a pre-trained speech/non-speech GMM model, for example. The HNR is calculated by a method based on the cepstrum (see Reference Literature 1), for example.
Reference Literature 1: Peter Murphy, Olatunji Akande, “Cepstrum-Based Harmonics-to-Noise Ratio Measurement in Voiced Speech”, Lecture Notes in Artificial Intelligence, Nonlinear Speech Modeling and Applications, Vol. 3445, Springer-Verlag, 2005.

By using more acoustic features, various features included in an utterance can be represented, and the emotion recognition accuracy tends to improve.

<First Emotion Recognition Model Training Unit 102>

Input: acoustic feature series of the input utterance training data; correct emotion labels

Output: first emotion recognition model

The first emotion recognition model training unit 102 uses the acoustic feature series of the input utterance training data and the correct emotion labels corresponding to the input utterance training data to train the first emotion recognition model (S102). The first emotion recognition model is a model that recognizes an emotion from an acoustic feature series of a certain utterance, accepting an acoustic feature series of utterance data as input and outputting an emotion recognition result. In the training of the model, the acoustic feature series of a certain utterance and the correct emotion label corresponding to the utterance are treated as a pair, and a large collection of such pairs is used.

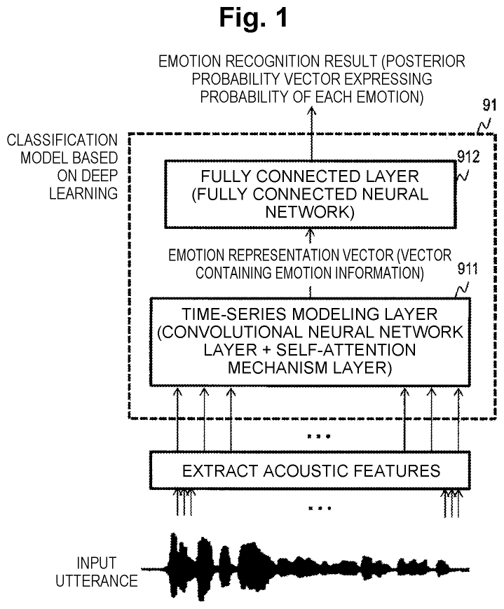

In the present embodiment, a classification model based on deep learning similar to the technology of the related art is used. Namely, a classification model including a time-series modeling layer combining a convolutional neural network with an attention mechanism layer, and a fully connected layer is used (see FIG. 1). Model parameters are updated by using pairs of an acoustic feature series and a correct emotion label for several utterances at a time, and by using stochastic gradient descent that applies error backpropagation to the loss function thereof, similarly to the technology of the related art.

<Emotion Representation Vector Extraction Model Acquisition Unit 103>

Input: first emotion recognition model

Output: emotion representation vector extraction model

The emotion representation vector extraction model acquisition unit 103 acquires a portion of the first emotion recognition model and creates an emotion representation vector extraction model (S103). Specifically, the emotion representation vector extraction model acquisition unit 103 uses only the time-series modeling layer as the emotion representation vector extraction model, and discards the fully connected layer. The emotion representation vector extraction model has a function of extracting from an acoustic feature series of any length an emotion representation vector, that is, a vector of fixed length effective for emotion recognition.

<Emotion Representation Vector Extraction Unit 104>

Input: acoustic feature series of input utterance training data; acoustic feature series of calm emotion utterance training data; emotion representation vector extraction model

Output: emotion representation vector of input utterance training data; emotion representation vector of calm emotion utterance training data

The emotion representation vector extraction unit 104 receives the emotion representation vector extraction model prior to the extraction process. The emotion representation vector extraction unit 104 uses the emotion representation vector extraction model to extract an emotion representation vector of the input utterance training data and an emotion representation vector of the calm emotion utterance training data from the acoustic feature series of the input utterance training data and the acoustic feature series of the calm emotion utterance training data, respectively (S104).

In the present embodiment, the emotion representation vector extraction model obtained as the output of the emotion representation vector extraction model acquisition unit 103 is used to extract emotion representation vectors. An emotion representation vector is outputted by forward-propagating an acoustic feature series to the model.

However, different rules can also be used to extract an emotion representation vector, without using an emotion representation vector extraction model. For example, utterance statistics about an acoustic feature series may be used as an emotion representation vector. A vector or the like including one or more from among the mean, the variance, the kurtosis, the skewness, the maximum value, or the minimum value may also be used as an emotion representation vector, for example. Using utterance statistics as an emotion representation vector has the merit of making an emotion representation vector extraction model unnecessary, but since there is a possibility that the utterance statistics will contain information about other ways of speaking and not just a representation of emotion, lowered emotion recognition accuracy is also a concern.

<Second Emotion Recognition Model Training Unit 105>

Input: emotion representation vector of input utterance training data; emotion representation vector of calm emotion utterance training data; correct emotion labels corresponding to input utterance training data

Output: second emotion recognition model

The second emotion recognition model training unit 105 uses the emotion representation vector of the input utterance training data and the emotion representation vector of the calm emotion utterance training data to train the second emotion recognition model by using the correct emotion labels corresponding to the input utterance training data as teaching data (S105). The second emotion recognition model is a model that accepts an emotion representation vector of calm emotion utterance data and an emotion representation vector of input utterance data as input, and outputs an emotion recognition result.

In the present embodiment, the second emotion recognition model is assumed to be a model comprising one or more fully connected layers. Also, a supervector obtained by concatenating an emotion representation vector of calm emotion utterance data and an emotion representation vector of input utterance data is used as the input into the model, but a vector of the difference between the above two vectors may also be used. To update the model parameters, stochastic gradient descent is used similarly to the first emotion recognition model training unit 102.

<Emotion Recognition Device 200>

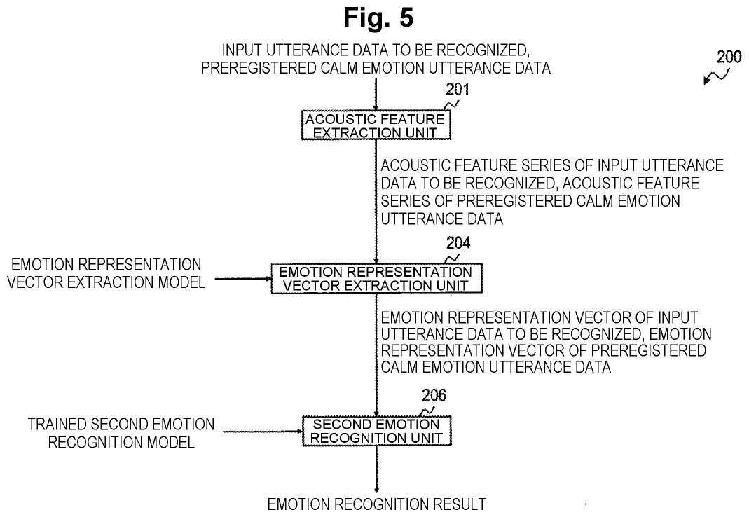

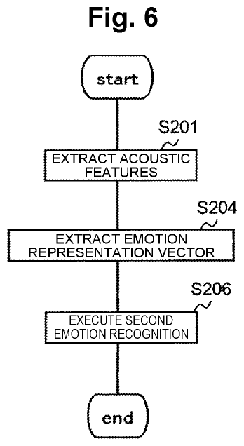

FIG. 5 is a function block diagram of the emotion recognition device 200 according to the first embodiment, and FIG. 6 illustrates a process flow by the same.

The emotion recognition device 200 includes an acoustic feature extraction unit 201, an emotion representation vector extraction unit 204, and a second emotion recognition unit 206.

The emotion recognition device 200 receives the emotion representation vector extraction model and the second emotion recognition model prior to the emotion recognition process. The emotion recognition device 200 accepts input utterance data to be recognized and preregistered calm emotion utterance data from the same speaker as the input utterance data to be recognized as input, uses the second emotion recognition model to recognize an emotion corresponding to the input utterance data to be recognized, and outputs a recognition result.

First, the preregistered calm emotion utterance data by the speaker whose emotions are to be recognized is registered in advance. For example, a combination of a speaker identifier indicating the speaker and the preregistered calm emotion utterance data is stored in a storage unit not illustrated.

When executing the emotion recognition process, the emotion recognition device 200 receives the input utterance data to be recognized as input.

An emotion representation vector is extracted from each of the preregistered calm emotion utterance data registered in advance and the input utterance data to be recognized. The method of extracting an emotion representation vector is assumed to be the same as the emotion representation vector extraction unit 104 of the emotion recognition model training device 100. Also, in the case where some kind of model is necessary for the extraction (for example, in the case of using the intermediate output from a deep learning classification model as the emotion representation vector), the same model as the emotion recognition model training device 100 (for example, an emotion representation vector extraction model) is used.

The emotion recognition device 200 inputs the extracted emotion representation vector of a calm emotion utterance and the extracted emotion representation vector of an input utterance into the second emotion recognition model trained by the emotion recognition model training device 100, and obtains an emotion recognition result.

Note that if singular preregistered calm emotion utterance data is registered in advance, one or a plurality of input utterance data to be recognized by the same speaker can be associated with the preregistered calm emotion utterance data, and one or more emotion recognition results can be obtained.

Hereinafter, each unit will be described.

<Acoustic Feature Extraction Unit 201>

Input: input utterance data to be recognized; preregistered calm emotion utterance data

Output: acoustic feature series of the input utterance data to be recognized; acoustic feature series of preregistered calm emotion utterance data

The acoustic feature extraction unit 201 extracts an acoustic feature series from each of the input utterance data to be recognized and the preregistered calm emotion utterance data (S201). The extraction method is similar to the acoustic feature extraction unit 101.

<Emotion Representation Vector Extraction Unit 204>

Input: acoustic feature series of the input utterance data to be recognized; acoustic feature series of preregistered calm emotion utterance data; emotion representation vector extraction model

Output: emotion representation vector of input utterance data to be recognized; emotion representation vector of preregistered calm emotion utterance data

The emotion representation vector extraction unit 204 uses the emotion representation vector extraction model to extract an emotion representation vector from the acoustic feature series of the input utterance data to be recognized and the acoustic feature series of the preregistered calm emotion utterance data, respectively (S204). The extraction method is similar to the emotion representation vector extraction unit 104.

<Second Emotion Recognition Unit 206>

Input: emotion representation vector of input utterance data to be recognized; emotion representation vector of preregistered calm emotion utterance data; second emotion recognition model

Output: emotion recognition result

The second emotion recognition unit 206 receives the second emotion recognition model prior to the recognition process. The second emotion recognition unit 206 uses the second emotion recognition model to obtain an emotion recognition result regarding the input utterance data to be recognized from the emotion representation vector of the preregistered calm emotion utterance data and the emotion representation vector of the input utterance data to be recognized (S206). For example, a supervector obtained by concatenating the emotion representation vector of the preregistered calm emotion utterance data and the emotion representation vector of the input utterance data to be recognized or a vector of the difference between the emotion representation vector of the preregistered calm emotion utterance data and the emotion representation vector of the input utterance data to be recognized is treated as input and forward-propagated to the second emotion recognition model, thereby obtaining an emotion recognition result through comparison with a calm emotion utterance. The emotion recognition result includes a posterior probability vector (the output of the forward propagation of the second emotion recognition model) for each emotion. The emotion class with the maximum posterior probability vector is used as the final emotion recognition result.

<Effects>

According to the above configuration, it is possible to reduce the bias in emotion recognition results for each speaker and achieve high emotion recognition accuracy with respect to all speakers.

### Second Embodiment

The portions that differ from the first embodiment will be described mainly.

In the present embodiment, when executing the recognition process, a plurality of preregistered calm emotion utterance data is registered in advance and used with input utterance data to be recognized to perform emotion recognition through a comparison with the plurality of preregistered calm emotion utterance data, and the results are combined to obtain a final emotion recognition result.

In the first embodiment, emotion recognition is performed by comparing the input utterance data to be recognized to singular preregistered calm emotion utterance data, but by estimating which emotion is expressed through comparisons with a variety of preregistered calm emotion utterance data, the emotion recognition accuracy is expected to improve. As a result, the emotion recognition accuracy is improved further.

In the present embodiment, let N be the total number of calm emotion utterance data registered in advance, and let the calm emotion utterance data n be the calm emotion utterance registered in the nth place (where n=1, . . . , N). The value of N is an integer equal to or greater than 1, and the speaker of the input utterance data to be recognized is the same as the speaker of the N pieces of calm emotion utterance data.

Since the emotion recognition model training device is the same as the first embodiment, the emotion recognition device will be described.

<Emotion Recognition Device 300>

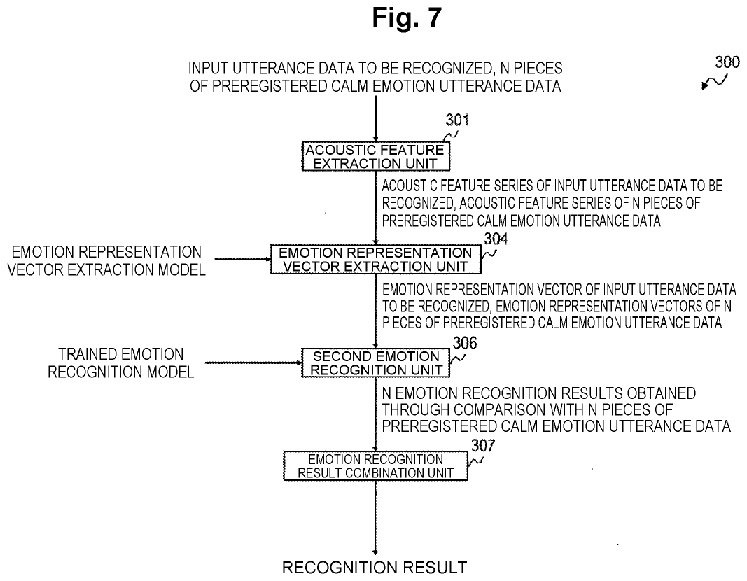

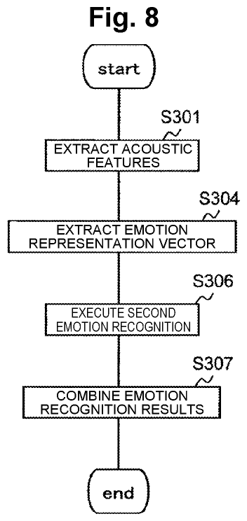

FIG. 7 is a function block diagram of an emotion recognition device 300 according to the second embodiment, and FIG. 8 illustrates a process flow by the same.

The emotion recognition device 300 includes an acoustic feature extraction unit 301, an emotion representation vector extraction unit 304, a second emotion recognition unit 306, and an emotion recognition result combination unit 307.

Prior to the emotion recognition process, the emotion recognition device 300 receives an emotion representation vector extraction model and an emotion recognition model that recognizes emotion through comparison with calm emotion utterances. The emotion recognition device 300 accepts input utterance data to be recognized and N pieces of preregistered calm emotion utterance data from the same speaker as the input utterance data to be recognized as input, uses the emotion recognition model that recognizes emotion through comparison with calm emotion utterances to recognize N emotions corresponding to the input utterance data to be recognized, combines the N emotion recognition results, and outputs the combination as a final emotion recognition result.

First, the N pieces of preregistered calm emotion utterance data by the speaker whose emotions are to be recognized are registered in advance. For example, a combination of a speaker identifier indicating the speaker and the N pieces of preregistered calm emotion utterance data is stored in a storage unit not illustrated.

When executing the emotion recognition process, the emotion recognition device 300 receives the input utterance data to be recognized as input.

An emotion representation vector is extracted from each of the N pieces of preregistered calm emotion utterance data registered in advance and the input utterance data to be recognized. The method of extracting an emotion representation vector is assumed to be the same as the emotion representation vector extraction unit 204 of the emotion recognition device 200.

The emotion recognition device 300 inputs the extracted emotion representation vectors of the N pieces of calm emotion utterance data and the extracted emotion representation vector of input utterance data to be recognized into the second emotion recognition model trained by the emotion recognition model training device 100, and obtains N emotion recognition results. Additionally, the emotion recognition device 300 combines the N emotion recognition results to obtain a final emotion recognition result.

Note that if N pieces of preregistered calm emotion utterance data are registered in advance, one or a plurality of input utterance data to be recognized by the same speaker can be associated with the N pieces of preregistered calm emotion utterance data, and one or more final emotion recognition results can be obtained.

Hereinafter, each unit will be described.

<Acoustic Feature Extraction Unit 301>

Input: input utterance data to be recognized; N pieces of preregistered calm emotion utterance data

Output: acoustic feature series of input utterance data to be recognized; N acoustic feature series of N pieces of preregistered calm emotion utterance data

The acoustic feature extraction unit 301 extracts an acoustic feature series from each of the input utterance data to be recognized and the N pieces of preregistered calm emotion utterance data (S301). The extraction method is similar to the acoustic feature extraction unit 201.

<Emotion Representation Vector Extraction Unit 304>

Input: acoustic feature series of input utterance data to be recognized; N acoustic feature series of N pieces of preregistered calm emotion utterance data; emotion representation vector extraction model

Output: emotion representation vector of input utterance data to be recognized; N emotion representation vectors of N pieces of preregistered calm emotion utterance data

The emotion representation vector extraction unit 304 uses the emotion representation vector extraction model to extract an emotion representation vector of the input utterance data to be recognized and N emotion representation vectors of the N pieces of preregistered calm emotion utterance data from the acoustic feature series of the input utterance data to be recognized and the N acoustic feature series of the N pieces of preregistered calm emotion utterance data, respectively (S304). The extraction method is similar to the emotion representation vector extraction unit 204.

<Second Emotion Recognition Unit 306>

Input: emotion representation vector of input utterance data to be recognized; emotion representation vectors of N pieces of preregistered calm emotion utterance data; second emotion recognition model

Output: N emotion recognition results obtained through comparison with each of N calm emotion utterances

The second emotion recognition unit 306 receives the second emotion recognition model prior to the recognition process. The second emotion recognition unit 306 uses the second emotion recognition model to obtain N emotion recognition results regarding the input utterance data to be recognized from the emotion representation vector of the input utterance data to be recognized and the emotion representation vectors of the N pieces of preregistered calm emotion utterance data (S306). For example, the second emotion recognition unit 306 accepts a supervector obtained by concatenating the emotion representation vector of the nth preregistered calm emotion utterance data and the emotion representation vector of the input utterance data to be recognized or a vector of the difference between the emotion representation vector of the nth preregistered calm emotion utterance data and the emotion representation vector of the input utterance data to be recognized as input, and forward-propagates to the second emotion recognition model to thereby obtain the nth emotion recognition result through comparison with the nth calm emotion utterance. The emotion recognition result includes a posterior probability vector (the output of the forward propagation of the emotion recognition model through comparison with a calm emotion utterance) for each emotion.

For example, the nth emotion recognition result p(n) includes a posterior probability p(n, t) for each emotion label t obtained by forward-propagating a supervector obtained by concatenating the emotion representation vector of the input utterance data to be recognized and the emotion representation vector of the nth preregistered calm emotion utterance data or a vector of the difference between the emotion representation vector of the input utterance data to be recognized and the emotion representation vector of the nth preregistered calm emotion utterance data to the emotion recognition model through a comparison with a calm emotion utterance. Here, p(n)=(p(n, 1), p(n, 2), . . . , p(n, T)), where T is the total number of emotion labels, and t=1, 2, . . . , T.

<Emotion Recognition Result Combination Unit 307>

Input: N emotion recognition results obtained through comparison with each of N calm emotion utterances

Output: combined emotion recognition result

When a plurality of emotion recognition results are obtained through comparisons with calm emotion utterances, the emotion recognition result combination unit 307 combines the plurality of emotion recognition results to obtain a combined emotion recognition result. The combined emotion recognition result is treated as the final emotion recognition result.

In the present embodiment, in the combined emotion recognition result, the final posterior probability vector for each emotion is the average of the posterior probability vectors for each emotion included in the set of “the emotion recognition result obtained through a comparison with the preregistered calm emotion utterance data 1, . . . , the emotion recognition result obtained through a comparison with the preregistered calm emotion utterance data N”, and the emotion class having the largest value from among the averages is the final emotion recognition result. However, the final emotion recognition result may also be determined by a majority vote of the emotion class having the largest posterior probability vector in the set of “the emotion recognition result obtained through a comparison with the preregistered calm emotion utterance data 1, . . . , the emotion recognition result obtained through a comparison with the preregistered calm emotion utterance data N”.

For example, the final emotion recognition result of the emotion recognition result combination unit 307 is calculated by

(1) averaging the posterior probability p(n, t) for each emotion label t and calculating T average posterior probabilities according to

$${p}_{ave} ( t ) = \frac{p ( 1 , t ) + p ( 2 , t ) + … + p ( N , t )}{N} \qquad [ Math . 1 ]$$

and treating the emotion label corresponding to the largest average posterior probability among the T average posterior probabilities pₐᵥₑ(t) as the final emotion recognition result, or alternatively,

(2) calculating the emotion label having the largest posterior probability p(n, t) for each nth emotion recognition result p(n) according to

$$L a b e {l}_{max} ( n ) {←}_{t} argmax ( p ( n , t ) ) \qquad [ Math . 2 ]$$

and treating the emotion label with the highest occurrence among the N Labelₘₐₓ(n) as the final emotion recognition result.

<Effects>

According to the above configuration, effects similar to the first embodiment can be obtained. Furthermore, by comparing against a variety of preregistered calm emotion utterance data to infer what kind of emotion is being expressed, the emotion recognition accuracy is expected to improve. Note that an emotion recognition device of the present embodiment in which N=1 and the emotion recognition result combination unit 307 is omitted corresponds to the emotion recognition device of the first embodiment.

### Third Embodiment

The portions that differ from the first embodiment will be described mainly.

In the present embodiment, a final emotion recognition result is obtained by combining emotion recognition through a comparison with a calm emotion utterance and emotion recognition of the utterance itself according to the technology of the related art.

Emotion recognition through comparison with a calm emotion utterance is a method of using “emotion recognition through a comparison with the way in which a certain speaker normally speaks”, but performing emotion recognition on the basis of the features of the way of speaking in the input utterance itself is also effective. For example, human beings are capable of perceiving the emotion of another person to some degree from the other person's way of speaking, even if the other person is mostly a stranger, and therefore the features of the way of speaking in the input utterance itself are also important in emotion recognition. This being the case, by combining emotion recognition through a comparison with a calm emotion utterance and emotion recognition of the utterance itself, the emotion recognition accuracy is expected to improve further.

Since the emotion recognition model training device is the same as the first embodiment, the emotion recognition device will be described. However, the first emotion recognition model outputted from the first emotion recognition model training unit 102 of the emotion recognition model training device 100 is outputted not only to the emotion representation vector extraction model acquisition unit 103, but also to an emotion recognition device 400.

<Emotion Recognition Device 400>

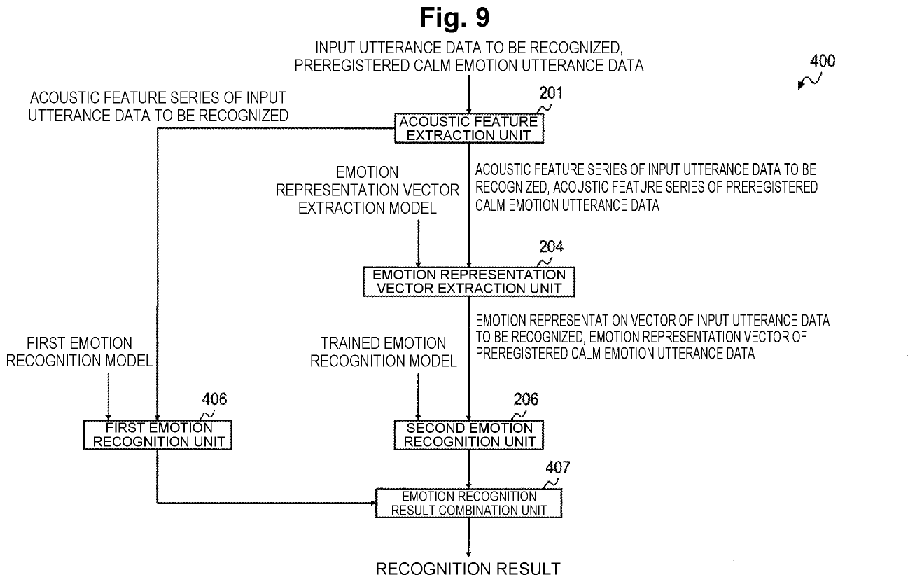

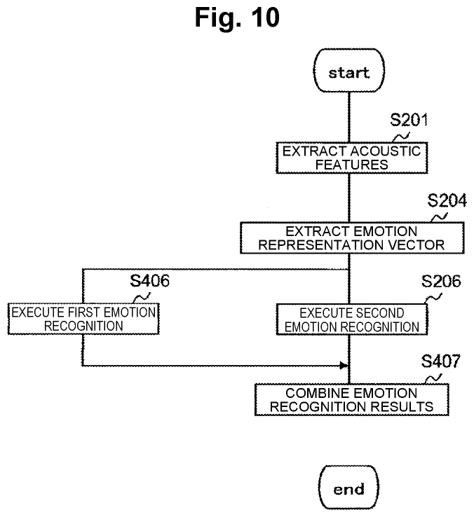

FIG. 9 is a function block diagram of the emotion recognition device 400 according to the third embodiment, and FIG. 10 illustrates a process flow by the same.

The emotion recognition device 400 includes an acoustic feature extraction unit 201, an emotion representation vector extraction unit 204, a second emotion recognition unit 206, a first emotion recognition unit 406, and an emotion recognition result combination unit 407.

The emotion recognition device 400 receives the emotion representation vector extraction model, the second emotion recognition model, and also the first emotion recognition model prior to the emotion recognition process. The emotion recognition device 400 accepts input utterance data to be recognized and preregistered calm emotion utterance data from the same speaker as the input utterance data to be recognized as input, and uses the second emotion recognition model to recognize an emotion corresponding to the input utterance data to be recognized. Moreover, the emotion recognition device 400 accepts the input utterance data to be recognized as input, and uses the first emotion recognition model to recognize an emotion corresponding to the input utterance data to be recognized. The emotion recognition device 400 combines the two emotion recognition results and outputs the combined result as the final emotion recognition result.

First, the preregistered calm emotion utterance data by the speaker whose emotions are to be recognized is registered in advance. For example, a combination of a speaker identifier indicating the speaker and the preregistered calm emotion utterance data is stored in a storage unit not illustrated.

When executing the emotion recognition process, the emotion recognition device 400 receives the input utterance data to be recognized as input.

An emotion representation vector is extracted from each of the preregistered calm emotion utterance data registered in advance and the input utterance data to be recognized. The method of extracting an emotion representation vector is assumed to be the same as the emotion representation vector extraction unit 104 of the emotion recognition model training device 100. Also, in the case where some kind of model is necessary for the extraction (for example, in the case of using the intermediate output from a deep learning classification model as the emotion representation vector), the same model as the emotion recognition model training device 100 is used.

The emotion recognition device 400 inputs the extracted emotion representation vector of a calm emotion utterance and the extracted emotion representation vector of an input utterance into the model that performs the second emotion recognition, and obtains an emotion recognition result. The emotion recognition device 400 inputs the acoustic feature series of the input utterance data to be recognized into the first emotion recognition model, and obtains an emotion recognition result. Note that the first emotion recognition model uses the model trained by the first emotion recognition model training unit 102 of the first embodiment. Additionally, the emotion recognition device 400 combines the two emotion recognition results to obtain a final emotion recognition result.

Hereinafter, the first emotion recognition unit 406 and the emotion recognition result combination unit 407 that differ from the first embodiment will be described.

<First Emotion Recognition Unit 406>

Input: acoustic feature series of input utterance data to be recognized; first emotion recognition model

Output: emotion recognition result

The first emotion recognition unit 406 uses the first emotion recognition model to obtain an emotion recognition result regarding the input utterance data to be recognized from the acoustic feature series of the input utterance data to be recognized (S406). The emotion recognition result includes a posterior probability vector for each emotion. The posterior probability vector for each emotion is obtained as the output from forward-propagating the acoustic feature series to the first emotion recognition model.

<Emotion Recognition Result Combination Unit 407>

Input: emotion recognition result of second emotion recognition model; emotion recognition result of first emotion recognition model

Output: combined emotion recognition result

When the emotion recognition result of the second emotion recognition model and the emotion recognition result of the first emotion recognition model are obtained, the emotion recognition result combination unit 407 combines the results to obtain a combined emotion recognition result (S407). The combined emotion recognition result is treated as the final emotion recognition result. The combining method is conceivably a method similar to the emotion recognition result combination unit 307 of the second embodiment.

For example, the final emotion recognition result of the emotion recognition result combination unit 407 is calculated by

(1) averaging the posterior probability p(n, t) for each emotion label t and calculating T average posterior probabilities according to

$${p}_{ave} ( t ) = \frac{p ( 1 , t ) + p ( 2 , t ) + … + p ( N , t )}{N} \qquad [ Math . 3 ]$$

and treating the emotion label corresponding to the largest average posterior probability among the T average posterior probabilities pₐᵥₑ(t) as the final emotion recognition result. However, in the present embodiment, N=2.

<Effects>

According to the above configuration, effects similar to the first embodiment can be obtained. Furthermore, by inferring emotion with consideration for the features of the way of speaking in the input utterance itself, the emotion recognition accuracy is expected to improve.

<Modification>

The present embodiment and the second embodiment may also be combined. In this case, the emotion recognition result combination unit combines N emotion recognition results of the second emotion recognition model with the emotion recognition result of the first emotion recognition model to obtain a combined emotion recognition result. The combining method is conceivably a method (averaging or majority vote) similar to the emotion recognition result combination unit 307 of the second embodiment.

<Other Modifications>

The present invention is not limited to the foregoing embodiments and modifications. For example, the various processes described above not only may be executed in a time series in the order described, but may also be executed in parallel or individually according to the processing performance of the device executing the process, or as needed. Otherwise, appropriate modifications are possible without departing from the gist of the present invention.

<Program and Recording Medium>

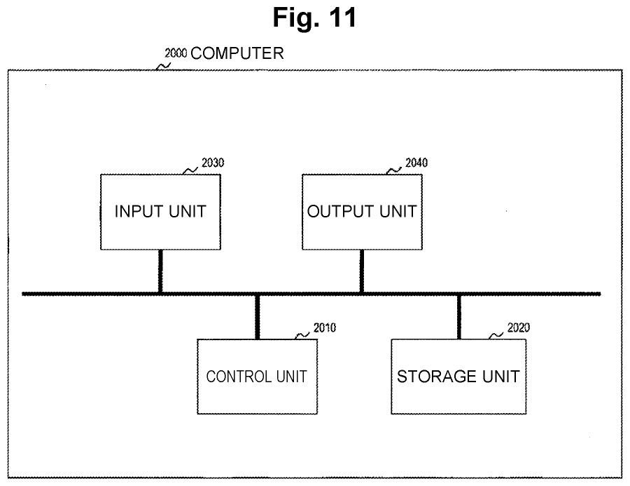

The various processes described above can be achieved by loading a program for causing the computer illustrated in FIG. 11 to execute each step described above into a storage unit 2020 of the computer, and causing components such as a control unit 2010, an input unit 2030, and an output unit 2040 to operate.

The program stating the processing content can be recorded to a computer-readable recording medium. The computer-readable recording medium may be any type of medium such as a magnetic recording device, an optical disc, a magneto-optical recording medium, or semiconductor memory, for example.

Also, the program is distributed by selling, transferring, or lending a portable recording medium such as a DVD or CD-ROM on which the program is recorded, for example. Furthermore, the program may also be stored in a storage device of a server computer and distributed by transferring the program from the server computer to another computer over a network.

The computer that executes such a program first stores the program recorded on the portable recording medium or the program transferred from the server computer in its own storage device, for example. Additionally, when executing processes, the computer loads the program stored in its own recording medium, and executes processes according to the loaded program. Also, as a different mode of executing the program, the computer may be configured to load the program directly from the portable recording medium and execute processes according to the program, and furthermore, the computer may be configured to execute processes according to the received program in succession every time the program is transferred to the computer from the server computer. Also, a configuration for executing the processes described above may also be achieved by what is called an application service provider (ASP) type service, in which processing functions are achieved by an execution instruction and a result acquisition only, without transferring the program from the server computer to the computer. Note that the program in this mode is assumed to include accompanying information conforming to the program for processing by an electronic computer (such as data that is not direct instructions to the computer, but has properties that stipulate processing by the computer).

Also, in this mode, the device is configured by causing the predetermined program to be executed on the computer, but at least a portion of the processing content may also be achieved in hardware.

1. An emotion recognition device comprising a processor configured to execute a method comprising:
extracting, a first emotion representation vector representing emotion information included in input utterance data uttered by a speaker to be recognized;
extracting a second emotion representation vector representing emotion information included in preregistered calm emotion utterance data uttered by the speaker as the input utterance data to be recognized; and
obtaining, using a second emotion recognition model, an emotion recognition result based on the second emotion recognition model regarding the input utterance data to be recognized from the second emotion representation vector of the preregistered calm emotion utterance data and the first emotion representation vector of the input utterance data to be recognized, wherein
the second emotion recognition model accepts the first emotion representation vector of input utterance data and the second emotion representation vector of calm emotion utterance data as input, and outputs an emotion recognition result regarding the input utterance data.

2. The emotion recognition device according to claim 1, wherein
the preregistered calm emotion utterance data includes three or more pieces of preregistered calm emotion utterance data,
the processor further configured to execute a method comprising:
extracting emotion representation vectors of the three or more pieces of preregistered calm emotion utterance data;
obtaining three or more pieces of emotion recognition results; and
combining the three or more pieces of emotion recognition results and obtains an emotion recognition result associated with the input utterance data to be recognized.

3. The emotion recognition device according to claim 1, the processor further configured to execute a method comprising:
obtaining, using a first emotion recognition model, an emotion recognition result based on the first emotion recognition model from the input utterance data to be recognized; and
combining the emotion recognition result based on the first emotion recognition model and the emotion recognition result based on the second emotion recognition model and obtaining a final emotion recognition result associated with the input utterance data to be recognized, wherein
the first emotion recognition model includes a model that accepts input utterance data as input and outputs an emotion recognition result regarding the input utterance data.

4. An emotion recognition model training device comprising a processor configured to execute a method comprising:
training a second emotion recognition model by using first emotion representation vectors representing emotion information included in input utterance training data, second emotion representation vectors representing emotion information included in calm emotion utterance training data by the same speaker as the input utterance training data, and correct emotion labels for the input utterance training data, wherein
the second emotion recognition model accepts a first emotion representation vector of input utterance data and a second emotion representation vector of calm emotion utterance data as input, and outputs an emotion recognition result regarding the input utterance data.

5. A computer implemented method for recognizing emotion, the method comprising:
extracting a first emotion representation vector representing emotion information included in input utterance data by a speaker to be recognized;
extracting a second emotion representation vector representing emotion information included in preregistered calm emotion utterance data by the speaker as the input utterance data to be recognized; and
obtaining, using a second emotion recognition model, an emotion recognition result regarding the input utterance data to be recognized from the second emotion representation vector of the preregistered calm emotion utterance data and the first emotion representation vector of the input utterance data to be recognized, wherein
the second emotion recognition model accepts the first emotion representation vector of input utterance data and the second emotion representation vector of calm emotion utterance data as input, and outputs an emotion recognition result regarding the input utterance data.

6-7. (canceled)

8. The emotion recognition device according to claim 1, wherein the emotion information includes one or more classes associated with at least one of being calm, angry, happy, or sad.

9. The emotion recognition device according to claim 1, wherein the second emotion recognition model includes a deep learning model including a combination including at least one of:
a time-series modeling layer based on a convolutional neural network with an attention mechanism layer, or
a fully connected layer.

10. The emotion recognition device according to claim 1, wherein the second emotion recognition model includes a support vector machine.

11. The emotion recognition device according to claim 1, wherein the first emotion representation vector represents utterance statistics about an acoustic feature of at least a part of the input utterance data.

12. The emotion recognition model training device according to claim 4, wherein the emotion information includes one or more classes associated with at least one of being calm, angry, happy, or sad.

13. The emotion recognition model training device according to claim 4, wherein the second emotion recognition model includes a deep learning model including a combination including at least one of:
a time-series modeling layer based on a convolutional neural network with an attention mechanism layer, or
a fully connected layer.

14. The emotion recognition model training device according to claim 4, wherein the second emotion recognition model includes a support vector machine.

15. The emotion recognition model training device according to claim 4, wherein the first emotion representation vector represents utterance statistics about an acoustic feature of at least a part of the input utterance data.

16. The emotion recognition model training device according to claim 4, the processor further configured to execute a method comprising:
identifying an acoustic feature series of the input utterance training data;
identifying a set of correct emotion labels corresponding to the input utterance training data; and
training, based on the acoustic feature series of the input utterance training data and the set of correct emotion labels corresponding to the input utterance training data, a first emotion recognition model.

17. The computer implemented method according to claim 5, wherein
the preregistered calm emotion utterance data includes three or more pieces of preregistered calm emotion utterance data,
the method further comprising:
extracting emotion representation vectors of the three or more pieces of preregistered calm emotion utterance data;
obtaining three or more pieces of emotion recognition results; and
combining the three or more pieces of emotion recognition results and obtains an emotion recognition result associated with the input utterance data to be recognized.

18. The computer implemented method according to claim 5, the method further comprising:
obtaining, using a first emotion recognition model, an emotion recognition result based on the first emotion recognition model from the input utterance data to be recognized; and
combining the emotion recognition result based on the first emotion recognition model and the emotion recognition result based on the second emotion recognition model and obtaining a final emotion recognition result associated with the input utterance data to be recognized, wherein
the first emotion recognition model includes a model that accepts input utterance data as input and outputs an emotion recognition result regarding the input utterance data.

19. The computer implemented method according to claim 5, wherein the emotion information includes one or more classes associated with at least one of being calm, angry, happy, or sad.

20. The computer implemented method according to claim 5, wherein the second emotion recognition model includes a deep learning model including a combination including at least one of:
a time-series modeling layer based on a convolutional neural network with an attention mechanism layer, or
a fully connected layer.

21. The computer implemented method according to claim 5, wherein the second emotion recognition model includes a support vector machine.

22. The computer implemented method according to claim 5, wherein the first emotion representation vector represents utterance statistics about an acoustic feature of at least a part of the input utterance data.
